(19) United States
(12) Patent Application Publication
(10) Pub. No.: US 2025/0245608 A1
(43) Pub. Date: Jul. 31, 2025

(54) INFORMATION PROCESSING APPARATUS, INFORMATION PROCESSING METHOD, AND NON-TRANSITORY COMPUTER READABLE MEDIUM

(71) Applicant: TOYOTA JIDOSHA KABUSHIKI KAISHA, Toyota-shi Aichi-ken (JP)

(72) Inventors: Mayuko ABE, Shinagawa-ku Tokyo-to (JP); Toshiki KASHIWAKURA, Ota-ku Tokyo-to (JP); Koki MORIYA, Nagakute-shi Aichi-ken (JP); Yuta TAKATA, Toyota-shi Aichi-ken (JP); Jean-Sebastien BOIRE, Yokohama-shi Kanagawa-ken (JP); Takashi YASUDA, Setagaya-ku Tokyo-to (JP); Tsuyoshi OKADA, Nagoya-shi Aichi-ken (JP)

(73) Assignee: TOYOTA JIDOSHA KABUSHIKI KAISHA, Toyota-shi Aichi-ken (JP)

(21) Appl. No.: 19/037,352

(22) Filed: Jan. 27, 2025

(30) Foreign Application Priority Data
Jan. 29, 2024 (JP) 2024-011320

(51) Int. Cl. G06Q 10/0833; G06Q 30/0207

(52) U.S. Cl. CPC G06Q 10/0833; G06Q 30/0207

(57) ABSTRACT

An information processing apparatus includes a controller configured to, in a case in which delivery of a package to a designated delivery point is not completed by a scheduled delivery time, provide a terminal apparatus owned by a customer who has ordered the package with a content that is set to be viewable by the customer, during delay time from the scheduled delivery time to a delivery completion time, at which the delivery of the package is completed.

### CROSS-REFERENCE TO RELATED APPLICATION

This application claims priority to Japanese Patent Application No. 2024-011320 filed on Jan. 29, 2024, the entire contents of which are incorporated herein by reference.

### TECHNICAL FIELD

The present disclosure relates to an information processing apparatus, an information processing method, and a non-transitory computer readable medium.

### BACKGROUND

Technology related to package delivery is known. For example, Patent Literature (PTL) 1 discloses technology in which, in delivery of a package with a designated receiving time, when there is a delay of more than predetermined time relative to the receiving time, service points are given according to delay time.

### CITATION LIST

### Patent Literature

PTL 1: JP 2005-316542 A

### SUMMARY

However, PTL 1 does not disclose any means of reducing stress on a user during a delay in package delivery. Therefore, there is room for improvement with respect to technology related to package delivery.

It would be helpful to improve technology related to package delivery.

An information processing apparatus according to an embodiment of the present disclosure is an information processing apparatus including:
a communication interface; and
a controller configured to establish communication by the communication interface,
wherein the controller is configured to, in a case in which delivery of a package to a designated delivery point is not completed by a scheduled delivery time, provide a terminal apparatus owned by a customer who has ordered the package with a content that is set to be viewable by the customer, during delay time from the scheduled delivery time to a delivery completion time at which the delivery of the package is completed.

An information processing method according to an embodiment of the present disclosure includes, in a case in which delivery of a package to a designated delivery point is not completed by a scheduled delivery time, providing, by an information processing apparatus, a terminal apparatus owned by a customer who has ordered the package with a content that is set to be viewable by the customer, during delay time from the scheduled delivery time to a delivery completion time at which the delivery of the package is completed.

A non-transitory computer readable medium according to an embodiment of the present disclosure stores a program configured to cause an information processing apparatus to execute operations, the operations including, in a case in which delivery of a package to a designated delivery point is not completed by a scheduled delivery time, providing a terminal apparatus owned by a customer who has ordered the package with a content that is set to be viewable by the customer, during delay time from the scheduled delivery time to a delivery completion time at which the delivery of the package is completed.

According to an embodiment of the present disclosure, technology related to package delivery is improved.

### BRIEF DESCRIPTION OF THE DRAWINGS

In the accompanying drawings:

FIG. 1 is a block diagram illustrating an example of a schematic configuration of a system according to an embodiment of the present disclosure;

FIG. 2 is a flowchart illustrating an example of operations of an information processing apparatus;

FIG. 3 is a schematic diagram illustrating an example of the system related to package delivery; and

FIG. 4 is a schematic diagram illustrating provision of a content and an incentive.

### DETAILED DESCRIPTION

Hereinafter, an embodiment of the present disclosure will be described.

### Outline of Embodiment

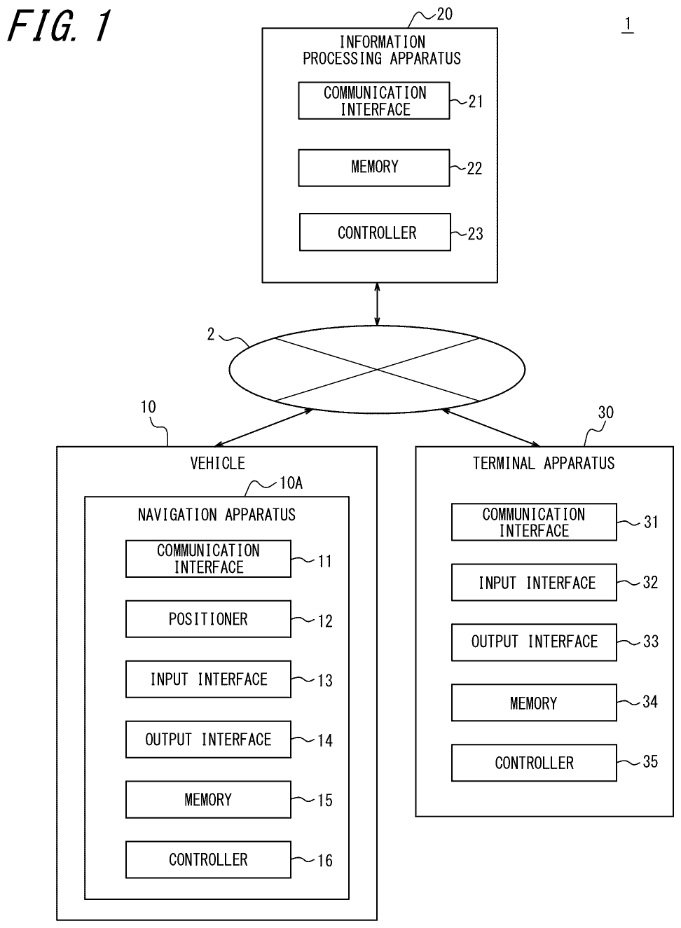

An outline of a system 1 according to the embodiment of the present disclosure will be described with reference to FIG. 1. The system 1 includes a vehicle 10, an information processing apparatus 20, and a terminal apparatus 30. The vehicle 10, the information processing apparatus 20, and the terminal apparatus 30 are communicably connected to a network 2 including, for example, the Internet, a mobile communication network, and the like.

The vehicle 10 is an automobile driven by a deliverer of a package delivery service provider, but may be any appropriate vehicle, not limited to the automobile. The automobile is a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these. The number of vehicles 10 provided in the system 1 may be freely determined.

The information processing apparatus 20 is, for example, a computer such as a server apparatus. The information processing apparatus 20 is communicably connected to the vehicle 10 and the terminal apparatus 30 via the network 2.

The terminal apparatus 30 is, for example, a smartphone, a tablet, a personal computer (PC), or the like, and may be any information processing terminal, not limited to these. The terminal apparatus 30 is a terminal apparatus owned by a customer who has ordered a package, and is communicably connected to the vehicle 10 and the information processing apparatus 20 via the network 2.

First, an outline of the present embodiment will be described, and details thereof will be described later. In a case in which delivery of a package to a designated delivery point is not completed by a scheduled delivery time, the information processing apparatus 20 provides a terminal apparatus 30 owned by a customer who has ordered the package with a content that is set to be viewable by the customer, during delay time from the scheduled delivery time to a delivery completion time at which the delivery of the package is completed.

According to the present embodiment, during the delay time in the delivery of the package, the content that is set to be viewable by the customer who has ordered the package is provided to the terminal apparatus 30. Thus, during the delay time in the delivery, the customer can view the content on the terminal apparatus 30. Therefore, technology related to package delivery is improved in terms of increase in a probability that stress on the customer due to delay in the delivery is reduced.

Next, configurations of the system 1 will be described in detail.

### (Configuration of Vehicle)

As illustrated in FIG. 1, the vehicle 10 includes a navigation apparatus 10A. The navigation apparatus 10A includes a communication interface 11, a positioner 12, an input interface 13, an output interface 14, a memory 15, and a controller 16.

The communication interface 11 includes at least one interface for communication for connecting to the network 2. The interface for communication is compliant with a mobile communication standard such as the 4th generation (4G) standard or the 5th generation (5G) standard, but is not limited to these. In the present embodiment, the navigation apparatus 10A installed in the vehicle 10 communicates with the information processing apparatus 20 and the terminal apparatus 30 via the communication interface 11 and the network 2.

The positioner 12 includes one or more apparatuses that acquire positional information on the vehicle 10. Specifically, the positioner 12 includes, for example, a receiver compliant with GPS, but is not limited to this example and may include a receiver compliant with any appropriate satellite positioning system.

The input interface 13 is configured with at least one interface for input that can accept input from the deliverer who drives the vehicle 10. The interface for input is, for example, a physical key, a capacitive key, a pointing device, a camera, a touch screen integrally provided with a display of the output interface 14 described below, a microphone that captures voice of the deliverer, or the like. However, the interface for input is not limited to these.

The output interface 14 is configured with at least one audio output interface that can output audio, and at least one display interface that can display text or video. The audio output interface is, for example, a speaker. The display interface is, for example, a display screen such as an LCD or an organic EL display. However, the audio output interface and the display interface are not limited to these.

The memory 15 includes one or more memories. The memories are, for example, semiconductor memories, magnetic memories, optical memories, or the like, but are not limited to these. The memories included in the memory 15 may each function as, for example, a main memory, an auxiliary memory, or a cache memory. The memory 15 stores any information used for operations of the vehicle 10. For example, the memory 15 may store a system program, an application program, embedded software, information (addresses, positional information, or the like) on delivery points of packages, scheduled delivery times of the packages, map information, and the like. The information stored in the memory 15 may be updated with, for example, information acquired from the network 2 via the communication interface 11.

The controller 16 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 16 controls operations of the entire navigation apparatus 10A.

### (Configuration of Information Processing Apparatus)

As illustrated in FIG. 1, the information processing apparatus 20 includes a communication interface 21, a memory 22, and a controller 23.

The communication interface 21 includes at least one interface for communication for connecting to the network 2. The interface for communication is compliant with, for example, but not limited to, a mobile communication standard, a wired local area network (LAN) standard, or a wireless LAN standard, and may be compliant with any appropriate communication standard. In the present embodiment, the information processing apparatus 20 communicates with the navigation apparatus 10A, which is installed in the vehicle 10, and the terminal apparatus 30 via the communication interface 21 and the network 2.

The memory 22 includes one or more memories. The memories included in the memory 22 may each function as, for example, a main memory, an auxiliary memory, or a cache memory. The memory 22 stores any information used for operations of the information processing apparatus 20. For example, the memory 22 may store a system program, an application program, a database, a content to be viewed by customers who have ordered packages, and the like. The information stored in the memory 22 may be updated with, for example, information acquired from the network 2 via the communication interface 21.

The controller 23 includes at least one processor, at least one programmable circuit, at least one dedicated circuit, or a combination of these. The controller 23 controls operations of the entire information processing apparatus 20.

### (Configuration of Terminal Apparatus)

As illustrated in FIG. 1, the terminal apparatus 30 includes a communication interface 31, an input interface 32, an output interface 33, a memory 34, and a controller 35.

The communication interface 31 is configured with at least one communication module for connecting to the network 2. The communication module is a communication module compliant with a mobile communication standard such as Long Term Evolution (LTE), the 4G standard, or the 5G standard. However, the communication module is not limited to these. The communication module may be compliant with any communication standard. In the present embodiment, the terminal apparatus 30 communicates with the navigation apparatus 10A, which is installed in the vehicle 10, and the information processing apparatus 20 via the communication interface 31 and the network 2.

The input interface 32 is configured with at least one interface for input that can accept input from the customer who orders a package. The interface for input is, for example, a physical key, a capacitive key, a pointing device, a touch screen integrally provided with a display, a microphone, or the like. However, the interface for input is not limited to these.

The output interface 33 can output data. The output interface 33 is configured with at least one interface for output that can output data. The interface for output is, for example, a display, a speaker, or the like. The display is, for example, an LCD, an organic EL display, or the like. However, the interface for output is not limited to these.

The memory 34 includes one or more memories. The memories are, for example, semiconductor memories, magnetic memories, optical memories, or the like, but are not limited to these. The memories included in the memory 34 may each function as, for example, a main memory, an auxiliary memory, or a cache memory. The memory 34 stores any information to be used for operations of the terminal apparatus 30. For example, the memory 34 may store a system program, an application program, embedded software, incentives provided by the information processing apparatus 20, and the like. The information stored in the memory 34 may be updated with, for example, information acquired from the network 2 via the communication interface 31.

The controller 35 is configured to with at least one processor, at least one dedicated circuit, or a combination thereof. The controller 35 executes processes related to operations of the terminal apparatus 30 while controlling components of the terminal apparatus 30.

### (Flow of Operations of Information Processing Apparatus)

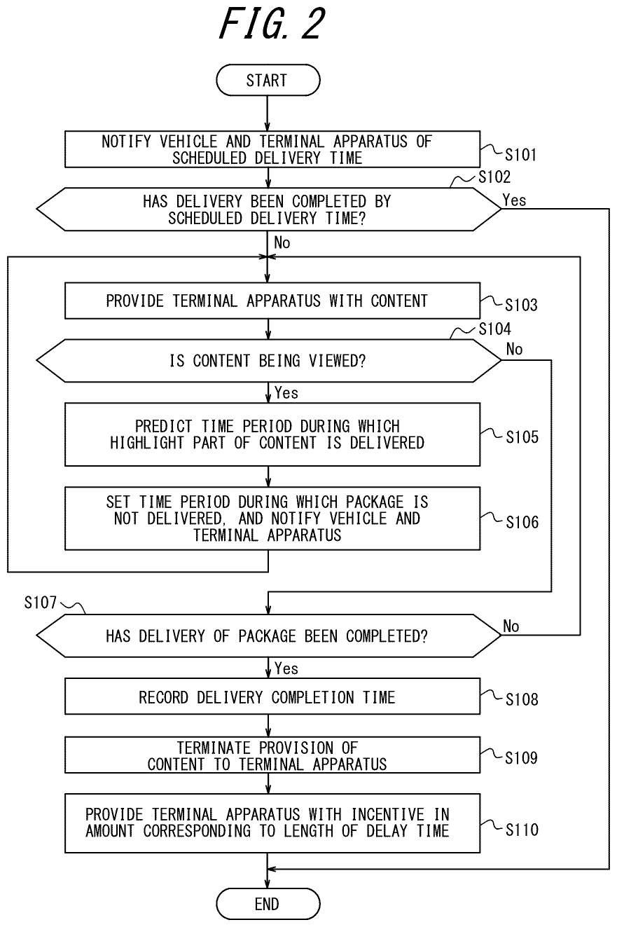

Operations of the information processing apparatus 20 according to the present embodiment will be described with reference to FIG. 2. These operations relate to provision of a content to a customer who has ordered a package, in a case in which delivery of the package delays.
S101: The controller 23 notifies the navigation apparatus 10A of the vehicle 10 and a terminal apparatus 30 owned by a customer 4, who has ordered a package 3, of a scheduled delivery time Te at which the package 3 is to be delivered to a designated delivery point Pd.
S102: The controller 23 checks whether delivery of the package 3 to the designated delivery point Pd has been completed by the scheduled delivery time Te. When the delivery has not been completed, the processing proceeds to S103. When the delivery has been completed, the processing is terminated.

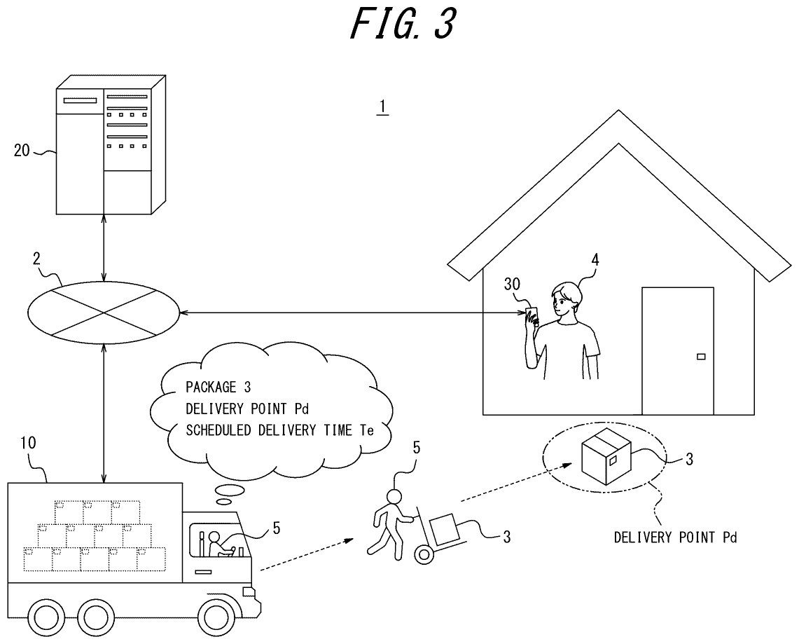

FIG. 3 is a schematic diagram illustrating an example of the system related to the delivery of the package 3. As illustrated in FIG. 3, the customer 4 requests the delivery of the package 3 with designating the delivery point Pd, to the information processing apparatus 20 via the terminal apparatus 30 and the network 2. The information processing apparatus 20 notifies the terminal apparatus 30 of the scheduled delivery time Te, and arranges for the delivery of the package 3 to the vehicle 10 (a deliverer 5 of a package delivery service provider) with designating the delivery point Pd and the scheduled delivery time Te.

The delivery point Pd is, for example, but not limited to, a sales office or handling store of the package delivery service provider, a convenience store, a locker in town, a porch in front of a front door of a home of the customer 4, or inside a delivery box at the home of the customer 4. The deliverer 5, who drives the vehicle 10, notifies the information processing apparatus 20 and the terminal apparatus 30 of the customer 4, via the communication interface 11 and the network 2, whether the delivery of the package 3 to the designated delivery point Pd has been completed by the scheduled delivery time Te.
S103: The controller 23 provides the terminal apparatus 30 owned by the customer 4, who has ordered the package 3, with a content that is set to be viewable by the customer 4.

The content is video, animation, music, and/or electronic books viewable by the customer 4 on the terminal apparatus 30. The content may be works provided by a video distribution service provider, a music distribution service provider, or an e-book service provider. The content may also be a game application, such as a computer game or a smartphone game, that runs on the terminal apparatus 30.

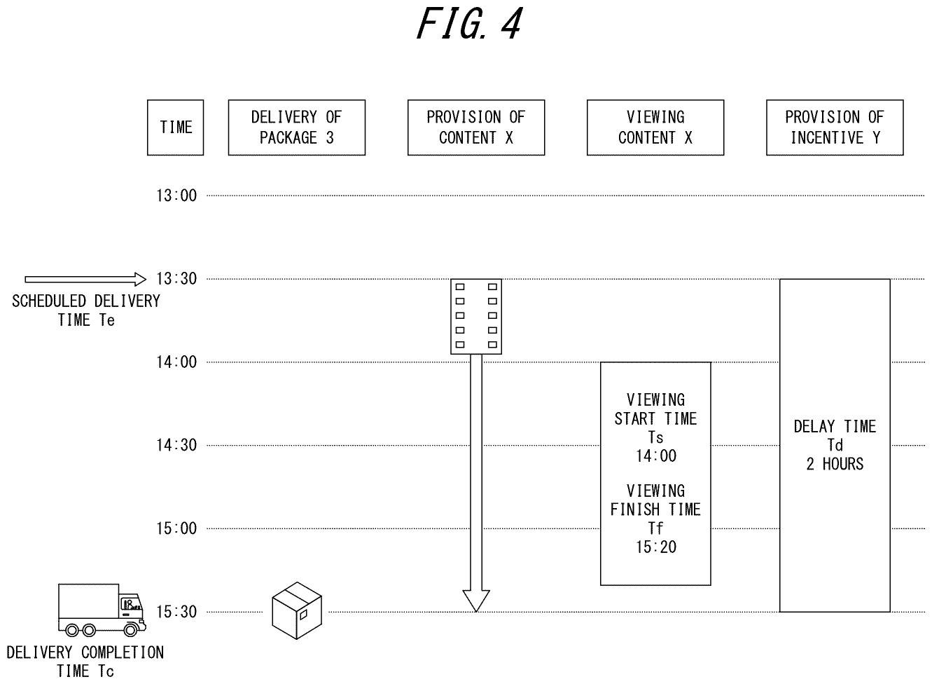

FIG. 4 is a schematic diagram illustrating provision of a content X and an incentive Y. As illustrated in FIG. 4, when the delivery of the package 3 has not been completed by the scheduled delivery time Te, the controller 23 provides the terminal apparatus 30, which is owned by the customer 4, with the content X that is set to be viewable by the customer 4 on the terminal apparatus 30. In the example of FIG. 4, the customer 4 starts viewing the content X at 14:00 (viewing start time Ts) and finishes viewing at 15:20 (viewing finish time Tf). The viewing time Tv from the viewing start time Ts to the viewing finish time Tf is 1 hour and 20 minutes. Delay time Td is the time from the scheduled delivery time Te to a delivery completion time Tc. Since the scheduled delivery time Te of the package 3 is 13:30 and the delivery completion time Tc is 15:30, the delay time Td is 2 hours. Thus, the controller 23 provides the terminal apparatus 30, which is owned by the customer 4 who has ordered the package 3, with the content X that is set to be viewable by the customer 4, during the 2-hour delay time Td from the scheduled delivery time Te to the delivery completion time Tc, at which the delivery of the package 3 is completed.

In addition to the provision of the content X, the controller 23 may provide the terminal apparatus 30 of the customer 4, who has ordered the package 3, with a discount service limited during the delay time Td at a predetermined website selling goods or services. In such a case, the controller 23 provides the terminal apparatus 30 with a link, such as a URL, to transition to the predetermined website.
S104: The controller 23 checks whether the provided content X is being viewed on the terminal apparatus 30. When the content X is being viewed, the processing proceeds to S105. When the content X is not being viewed, the processing proceeds to S107.
S105-S106: The controller 23 predicts a time period during which a highlight part of the content X is delivered, and sets the predicted time period as a time period during which the package 3 is not delivered.

For example, when the content X is a video (referred to as video X1), the highlight part is, for example, the most important or most moving highlight scene in the video X1. The controller 23 predicts, e.g., using AI, the time period during which the highlight scene is delivered during delivery of the video X1. For example, assume that the controller 23 predicts that a time period between 50 minutes and 65 minutes after a start of delivery of the video X1 is the time period of the highlight scene. In such a case, when the viewing start time Ts of the video X1 is 14:00, as illustrated in FIG. 4, the controller 23 sets a time period from 14:50 to 15:05, as the time period during which the package 3 is not delivered. The controller 23 notifies the navigation apparatus 10A of the vehicle 10, which the deliverer 5 drives, and the terminal apparatus 30 owned by the customer 4, via the network 2, of the set time period during which the package 3 is not delivered.

Upon receiving, from the terminal apparatus 30, a postponement request to postpone a delivery time, the controller 23 may accept the postponement request, and notify the navigation apparatus 10A of the vehicle 10 and the terminal apparatus 30 owned by the customer 4 of a scheduled delivery time Te that is reset in response to the postponement request.
S107: The controller 23 checks whether the delivery of the package 3 to the designated delivery point Pd has been completed. When the delivery has not been completed, the processing returns to S103. When the delivery has been completed, the processing proceeds to S108.

The deliverer 5 driving the vehicle 10 notifies the information processing apparatus 20 and the terminal apparatus 30 of the customer 4, via the communication interface 11 and the network 2, of the delivery completion time Tc at which the delivery of the package 3 to the designated delivery point Pd has been completed.
S108: The controller 23 acquires, from the vehicle 10, the delivery completion time Tc at which the package 3 has been delivered, and records the acquired delivery completion time Tc in the memory 22.
S109: The controller 23 terminates the provision of the content X at the delivery completion time Tc, at which the delivery of the package 3 to the delivery point Pd has been completed.

The provision of the content X to the terminal apparatus 30 may be automatically terminated at the delivery completion time Tc received from the vehicle 10.
S110: The controller 23 provides the terminal apparatus 30 with an incentive in an amount corresponding to the length of the delay time Td from the scheduled delivery time Te to the delivery completion time Tc.

The incentive may include, but are not limited to, service points, mileage, video viewing time, coupons, lotteries, and/or charged items for games. Referring again to FIG. 4. In the example illustrated in FIG. 4, the delay time Td from 13:30, the scheduled delivery time Te, to 15:30, the delivery completion time Tc, is 2 hours. The controller 23 provides the terminal apparatus 30 with service points in an amount corresponding to 2 hours. When a predetermined amount of service points is accumulated on the terminal apparatus 30, the customer 4 who owns the terminal apparatus 30 may receive, according to the point balance, a discount on the next product or service purchase price, or a bonus such as a reception of a product selected in a catalog gift at the next delivery.

As described above, when delivery of a package 3 to a designated delivery point Pd is not completed by a scheduled delivery time Te, the information processing apparatus 20 according to the present embodiment provides a terminal apparatus 30 owned by a customer 4, who has ordered the package 3, with a content X that is set to be viewable by the customer 4, during delay time Td from the scheduled delivery time Te to a delivery completion time Tc, at which the delivery of the package 3 is completed.

According to such a configuration, during the delay time Td in the delivery of the package 3, the terminal apparatus 30 is provided with the content X that is set to be viewable by the customer 4. Thus, during the delay time Td in the delivery, the customer 4 can view the content X on the terminal apparatus 30. Therefore, technology related to package delivery is improved in terms of increase in a probability that stress on the customer 4 due to delay in the delivery is reduced.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each configuration, each step, or the like can be rearranged without logical inconsistency, and a plurality of configurations, steps, or the like can be combined into one or divided.

For example, an embodiment in which the configuration and operations of the information processing apparatus 20 in the above embodiment are distributed to multiple computers capable of communicating with each other can be implemented. For example, an embodiment in which some or all of the components of the information processing apparatus 20 are provided in the vehicle 10 can also be implemented. For example, the navigation apparatus 10A installed in the vehicle 10 may be equipped with some or all of the components of the information processing apparatus 20.

For example, an embodiment in which a general purpose computer functions as the information processing apparatus 20 according to the above embodiment can also be implemented. Specifically, a program in which processes for realizing the functions of the information processing apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

Examples of some embodiments of the present disclosure are described below. However, it should be noted that the embodiments of the present disclosure are not limited to these examples.

[Appendix 1] An information processing apparatus comprising:
a communication interface; and
a controller configured to establish communication by the communication interface,
wherein the controller is configured to, in a case in which delivery of a package to a designated delivery point is not completed by a scheduled delivery time, provide a terminal apparatus owned by a customer who has ordered the package with a content that is set to be viewable by the customer, during delay time from the scheduled delivery time to a delivery completion time at which the delivery of the package is completed.

[Appendix 2] The information processing apparatus according to appendix 1, wherein the content is video, animation, music, and/or an electronic book.

[Appendix 3] The information processing apparatus according to appendix 1 or 2, wherein the controller is configured to further provide the terminal apparatus with a discount service limited during the delay time at a predetermined website that sells goods or services.

[Appendix 4] The information processing apparatus according to any one of appendices 1 to 3, wherein the controller is configured to, in a case in which the provided content is being viewed on the terminal apparatus, predict a time period during which a highlight part of the viewed content is delivered, and set the predicted time period as a time period during which the package is not delivered.

[Appendix 5] The information processing apparatus according to any one of appendices 1 to 4, wherein the controller is configured to provide the terminal apparatus with an incentive in an amount corresponding to a length of the delay time.

[Appendix 6] The information processing apparatus according to appendix 5, wherein the incentive is a service point, mileage, video viewing time, a coupon, a lottery, and/or a charged item for a game.

[Appendix 7] The information processing apparatus according to any one of appendices 1 to 6, wherein the controller is configured to, upon receiving, from the terminal apparatus, a postponement request to postpone a delivery time, notify the terminal apparatus of a scheduled delivery time set in response to the postponement request.

[Appendix 8] An information processing method comprising, in a case in which delivery of a package to a designated delivery point is not completed by a scheduled delivery time, providing, by an information processing apparatus, a terminal apparatus owned by a customer who has ordered the package with a content that is set to be viewable by the customer, during delay time from the scheduled delivery time to a delivery completion time at which the delivery of the package is completed.

[Appendix 9] The information processing method according to appendix 8, wherein the content is video, animation, music, and/or an electronic book.

[Appendix 10] The information processing method according to appendix 8 or 9, further comprising providing the terminal apparatus with a discount service limited during the delay time at a predetermined website that sells goods or services.

[Appendix 11] The information processing method according to any one of appendices 8 to 10, further comprising, in a case in which the provided content is being viewed on the terminal apparatus, predicting a time period during which a highlight part of the viewed content is delivered, and setting the predicted time period as a time period during which the package is not delivered.

[Appendix 12] The information processing method according to any one of appendices 8 to 11, further comprising providing the terminal apparatus with an incentive in an amount corresponding to a length of the delay time.

[Appendix 13] The information processing method according to appendix 12, wherein the incentive is a service point, mileage, video viewing time, a coupon, a lottery, and/or a charged item for a game.

[Appendix 14] The information processing method according to any one of appendices 8 to 13, further comprising, upon receiving, from the terminal apparatus, a postponement request to postpone a delivery time, notifying the terminal apparatus of a scheduled delivery time set in response to the postponement request.

[Appendix 15] A non-transitory computer readable medium storing a program configured to cause an information processing apparatus to execute operations, the operations comprising, in a case in which delivery of a package to a designated delivery point is not completed by a scheduled delivery time, providing a terminal apparatus owned by a customer who has ordered the package with a content that is set to be viewable by the customer, during delay time from the scheduled delivery time to a delivery completion time at which the delivery of the package is completed.

[Appendix 16] The medium according to appendix 15, wherein the content is video, animation, music, and/or an electronic book.

[Appendix 17] The medium according to appendix 15 or 16, wherein the operations further comprise providing the terminal apparatus with a discount service limited during the delay time at a predetermined website that sells goods or services.

[Appendix 18] The medium according to any one of appendices 15 to 17, wherein the operations further comprise, in a case in which the provided content is being viewed on the terminal apparatus, predicting a time period during which a highlight part of the viewed content is delivered, and setting the predicted time period as a time period during which the package is not delivered.

[Appendix 19] The medium according to any one of appendices 15 to 18, wherein the operations further comprise providing the terminal apparatus with an incentive in an amount corresponding to a length of the delay time.

[Appendix 20] The medium according to appendix 19, wherein the incentive is a service point, mileage, video viewing time, a coupon, a lottery, and/or a charged item for a game.

1. An information processing apparatus comprising:
a communication interface; and
a controller configured to establish communication by the communication interface,
wherein the controller is configured to, in a case in which delivery of a package to a designated delivery point is not completed by a scheduled delivery time, provide a terminal apparatus owned by a customer who has ordered the package with a content that is set to be viewable by the customer, during delay time from the scheduled delivery time to a delivery completion time at which the delivery of the package is completed.

2. The information processing apparatus according to claim 1, wherein the content is video, animation, music, and/or an electronic book.

3. The information processing apparatus according to claim 1, wherein the controller is configured to further provide the terminal apparatus with a discount service limited during the delay time at a predetermined website that sells goods or services.

4. The information processing apparatus according to claim 1, wherein the controller is configured to, in a case in which the provided content is being viewed on the terminal apparatus, predict a time period during which a highlight part of the viewed content is delivered, and set the predicted time period as a time period during which the package is not delivered.

5. The information processing apparatus according to claim 1, wherein the controller is configured to provide the terminal apparatus with an incentive in an amount corresponding to a length of the delay time.

6. The information processing apparatus according to claim 5, wherein the incentive is a service point, mileage, video viewing time, a coupon, a lottery, and/or a charged item for a game.

7. The information processing apparatus according to claim 1, wherein the controller is configured to, upon receiving, from the terminal apparatus, a postponement request to postpone a delivery time, notify the terminal apparatus of a scheduled delivery time set in response to the postponement request.

8. An information processing method comprising, in a case in which delivery of a package to a designated delivery point is not completed by a scheduled delivery time, providing, by an information processing apparatus, a terminal apparatus owned by a customer who has ordered the package with a content that is set to be viewable by the customer, during delay time from the scheduled delivery time to a delivery completion time at which the delivery of the package is completed.

9. The information processing method according to claim 8, wherein the content is video, animation, music, and/or an electronic book.

10. The information processing method according to claim 8, further comprising providing the terminal apparatus with a discount service limited during the delay time at a predetermined website that sells goods or services.

11. The information processing method according to claim 8, further comprising, in a case in which the provided content is being viewed on the terminal apparatus, predicting a time period during which a highlight part of the viewed content is delivered, and setting the predicted time period as a time period during which the package is not delivered.

12. The information processing method according to claim 8, further comprising providing the terminal apparatus with an incentive in an amount corresponding to a length of the delay time.

13. The information processing method according to claim 12, wherein the incentive is a service point, mileage, video viewing time, a coupon, a lottery, and/or a charged item for a game.

14. The information processing method according to claim 8, further comprising, upon receiving, from the terminal apparatus, a postponement request to postpone a delivery time, notifying the terminal apparatus of a scheduled delivery time set in response to the postponement request.

15. A non-transitory computer readable medium storing a program configured to cause an information processing apparatus to execute operations, the operations comprising, in a case in which delivery of a package to a designated delivery point is not completed by a scheduled delivery time, providing a terminal apparatus owned by a customer who has ordered the package with a content that is set to be viewable by the customer, during delay time from the scheduled delivery time to a delivery completion time at which the delivery of the package is completed.

16. The medium according to claim 15, wherein the content is video, animation, music, and/or an electronic book.

17. The medium according to claim 15, wherein the operations further comprise providing the terminal apparatus with a discount service limited during the delay time at a predetermined website that sells goods or services.

18. The medium according to claim 15, wherein the operations further comprise, in a case in which the provided content is being viewed on the terminal apparatus, predicting a time period during which a highlight part of the viewed content is delivered, and setting the predicted time period as a time period during which the package is not delivered.

19. The medium according to claim 15, wherein the operations further comprise providing the terminal apparatus with an incentive in an amount corresponding to a length of the delay time.

20. The medium according to claim 19, wherein the incentive is a service point, mileage, video viewing time, a coupon, a lottery, and/or a charged item for a game.
